(19) United States
(12) Patent Application Publication
(10) Pub. No.: US 2020/0158205 A1
(43) Pub. Date: May 21, 2020

(54) DAMPER FOR ENGINE MOUNTED WITH MOTOR

(71) Applicants: HYUNDAI MOTOR COMPANY, SEOUL (KR); KIA MOTORS CORPORATION, SEOUL (KR)

(72) Inventors: Jong Won Lee, Hwaseong-si (KR); Kyoung Pyo Ha, Seongnam-si (KR); Min Ki Ryu, Yongin-si (KR)

(21) Appl. No.: 16/280,627

(22) Filed: Feb. 20, 2019

(30) Foreign Application Priority Data
Nov. 15, 2018 (KR) 10-2018-0141046

(51) Int. Cl. F16F 15/131; B60K 6/40; B60K 6/36; F16F 15/121

(52) U.S. Cl. CPC F16F 15/13121; B60K 6/40; F16F 15/13135; F16F 15/121; B60K 6/36

(57) ABSTRACT

A damper for an engine mounted with a motor includes a first rotating body directly connected with an end portion of a crankshaft, a rotor constituting the motor and being integrally mounted at the first rotating body, a second rotating body installed at an inner side of the first rotating body to be rotatable relative to the first rotating body, and a first damper spring, a second damper spring and a third damper spring installed to be elastically deformed along a circumference direction between the first rotating body and the second rotating body. The first damper spring, the second damper spring and the third damper spring are all disposed within the length along the axial direction of the motor.

### CROSS REFERENCE TO RELATED APPLICATION

The present application claims priority of Korean Patent Application No. 10-2018-0141046 filed on Nov. 15, 2018 in the Korean Intellectual Property Office, the entire contents of which is incorporated by reference herein for all purposes.

### BACKGROUND OF THE DISCLOSURE

### Field of the Disclosure

The present disclosure relates to a technique for a damper for an engine, and more particularly, the present disclosure relates to a damper structure for an engine in which a motor is mounted.

### Description of the Related Art

A hybrid technology capable of using the power of an engine as an internal combustion engine with the power of a motor as an electric device has been widely applied to a vehicle.

There are various forms of power coupling between the engine and the motor to form a hybrid power train, and each forms has its own characteristics and merits and drawbacks.

Among such a hybrid power train, there is a so-called mild hybrid power train (Mild Hybrid Powertrain) in which a relatively small-capacity motor is directly connected to an engine to implement some of the functions of a hybrid vehicle such as an idle stop function.

However, in a power train configuration where a motor and a transmission such as a dual clutch transmission (DCT) are mounted sequentially in the engine, the overall length can be extended by a configuration coupled in series from the engine to the transmission, which can make it difficult to mount the engine and the transmission at a vehicle in a front engine front wheel (FF) vehicle that mounts the engine horizontally.

The foregoing is intended merely to aid in the understanding of the background of the present disclosure, and is not intended to mean that the present disclosure falls within the purview of the related art that is already known to those skilled in the art.

### SUMMARY OF THE DISCLOSURE

Accordingly, the present disclosure has been made keeping in mind the above problems occurring in the related art, and the present disclosure is intended to propose a damper for an engine mounted with a motor capable of dampening the power of an engine effectively to transmit it to a transmission while improving vehicle mountability by reducing the total length from the engine to the transmission, if possible, in a hybrid powertrain configuration where a motor is directly connected to the engine.

A damper for an engine mounted with a motor according to the present disclosure in order to achieve the above object may include, a first rotating body directly connected with an end portion of a crankshaft; a rotor constituting the motor and being integrally mounted at the first rotating body; a second rotating body installed at an inner side of the first rotating body to be rotatable relative to the first rotating body; and a first damper spring, a second damper spring and a third damper spring configured to be elastically deformed along a circumference direction between the first rotating body and the second rotating body; and wherein the first damper spring, the second damper spring and the third damper spring are all disposed within the length along the axial direction of the motor.

The second damper spring may be configured to be inserted into the outer side of the first damper spring.

An inner plate installed to pressurize the end portions of the first damper spring and the second damper spring along a circumference direction and an outer plate installed to pressurize an end portion of the third damper spring along a circumference direction, may be integrally provided at the second rotating body.

The inner plate and the outer plate may include cross-sectional shapes widening relative to each other toward the outer side along the radial direction of the second rotating body.

The first rotating body may have a cross-sectional shape forming a space covering the first damper spring, the second damper spring and the third damper spring together with the second rotating body; a hub part coupled to the crankshaft may be provided at the central portion thereof; and a circumference surface with a constant diameter at which the rotor can be mounted may be formed at the outer side thereof.

A spline into which a transmission input shaft is inserted may be formed at the center of the second rotating body.

A motor for a hybrid vehicle according to the present disclosure may include the damper as described above; and a stator disposed at the outer side of the rotor while forming an air gap.

A power train for a hybrid vehicle according to the present disclosure may include a motor including the damper as described above and a stator disposed at the outer side of a rotor while forming an air gap; and a transmission having an input shaft connected with the second rotating body.

The present disclosure can dampen the power of an engine effectively to transmit the power to a transmission while improving vehicle mountability by reducing the total length from the engine to the transmission, if possible, in a hybrid powertrain configuration where a motor is directly connected to the engine.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a cross sectional drawing of a damper for an engine mounted with a motor according to the present disclosure;

FIG. 2 is a drawing showing the first damper spring to the third damper spring provided at the damper shown in FIG. 1;

FIG. 3 is a three-dimensional cross-sectional view of the damper shown in FIG. 1; and

FIG. 4 is a three-dimensional cross-sectional view showing a part of the first rotating body shown in FIG. 1.

### DETAILED DESCRIPTION OF THE DISCLOSURE

Hereinafter, a damper for an engine mounted with a motor according to a preferred exemplary embodiment of the present disclosure will be described with reference to the attached drawing.

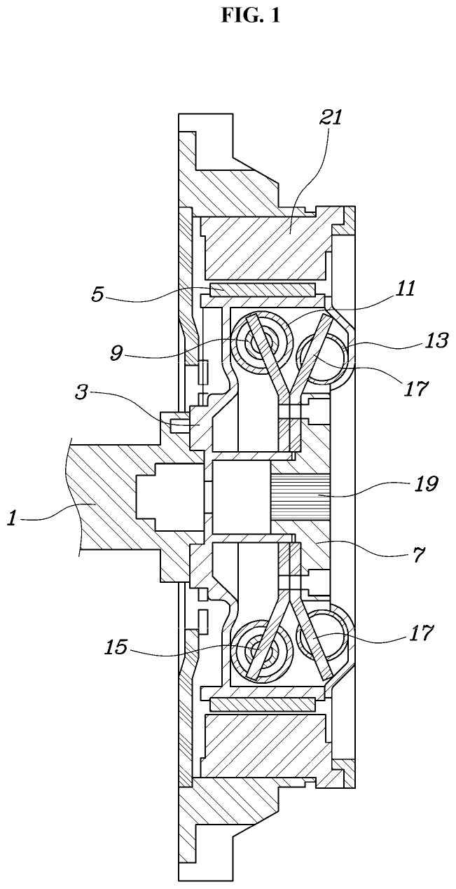

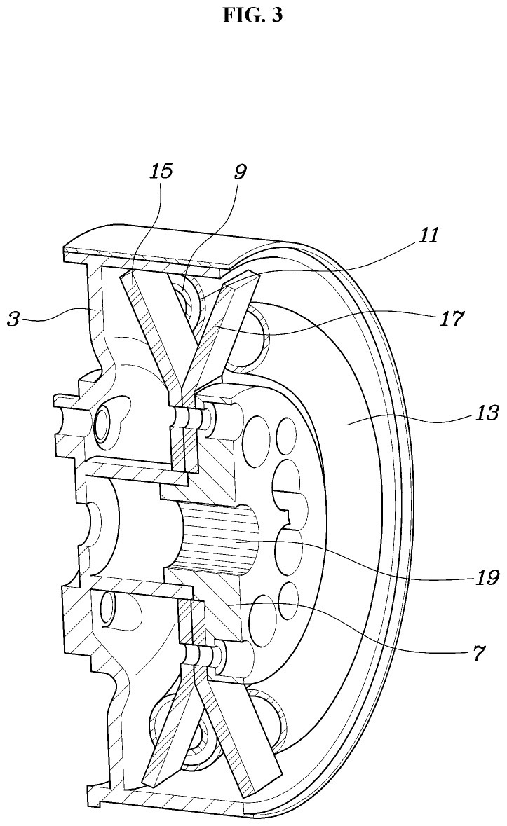

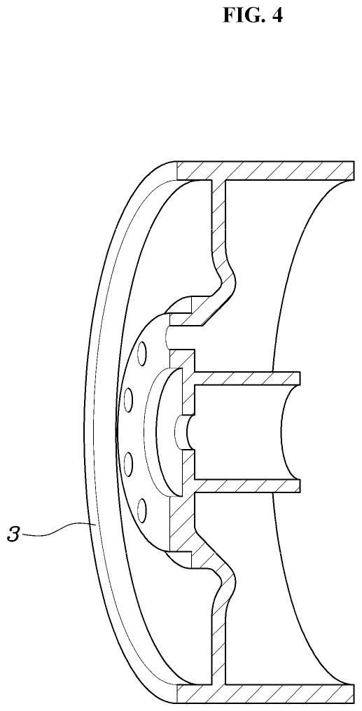

Referring to FIGS. 1 to 4, an exemplary embodiment of the damper for the engine mounted with the motor according to the present disclosure may include, a first rotating body 3 directly connected with an end portion of a crankshaft 1; a rotor 5 constituting a motor and being integrally mounted at the first rotating body 3; a second rotating body 7 installed at an inner side of the first rotating body 3 to be rotatable relative to the first rotating body; and a first damper spring 9, a second damper spring 11 and a third damper spring 13 installed to be elastically deformed along a circumference direction between the first rotating body 3 and the second rotating body 7. The first damper spring 9, the second damper spring 11 and the third damper spring 13 may be all disposed within the length along the axial direction of the motor.

That is, in the present disclosure, the first rotating body 3 and the second rotating body 7 may be elastically supported by the first damper spring 9, the second damper spring 11 and the third damper spring 13 inside the rotor 5 of the motor and disposed to be rotatable relative to each other. The entire motor and damper may therefore be implemented within the length of the motor by reducing the length that the conventional motor occupies and the separate length that the damper occupies to one, so that the entire length from an engine to a transmission can be substantially reduced, thereby ensuring vehicle mountability.

Herein, the second damper spring 11 may be installed in a state that it is inserted into the outside of the first damper spring 9.

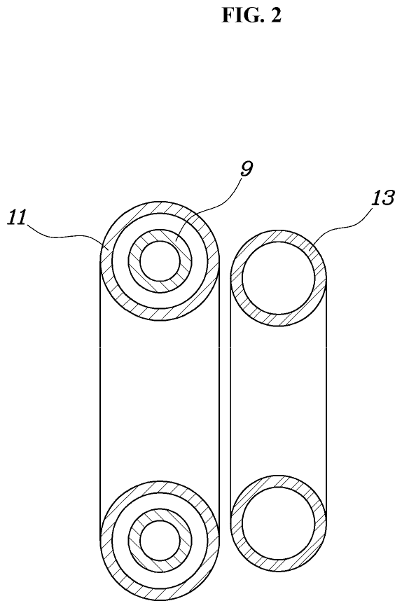

That is, the first damper spring 9 and the second damper spring 11, as shown in FIG. 2, may be configured to a double coil spring in which the first damper spring 9 is inserted into the second damper spring 11, so that the volume thereof is reduced to the volume of only the outer second damper spring 11. Thus, the first damper spring 9 and the second damper spring 11 may be inserted effectively within the limited space between the first rotating body 3 and the second rotating body 7 together with the third damper spring 13 while the required damping performance may be provided sufficiently.

As described above, in order to secure the required damping performance sufficiently even in a case that the diameters of the damper springs are limited by the structural limit that the damper springs should be installed inside the rotor 5 of the motor, the spring stiffness of each of the first damper spring 9, the second damper spring 11 and the third damper spring 13 may be set appropriately in terms of design by experiment and interpretation, and so on, in order to secure the required damping performance within the spatial and structural limits as described above. For example, the sum of the spring stiffnesses of the first damper spring 9 and the second damper spring 11 may be set to be equal to the spring stiffness of the third damper spring 13, or any one of the spring stiffness of the first damper spring 9 or the second damper spring 11 may be set to be equal to the spring stiffness of the third damper spring 13.

The second rotating body 7 may be integrally provided with an inner plate 15 installed to pressurize the end portions of the first damper spring 9 and the second damper spring 11 along a circumference direction and an outer plate 17 installed to pressurize an end portion of the third damper spring 13 along a circumference direction.

In the present exemplary embodiment, the inner plate 15 and the outer plate 17 may be installed with cross-sectional shapes widening relative to each other toward the outer side along the radial direction of the second rotating body 7.

Naturally, at the first rotating body 3 may be provided with a supporting protrusion (not shown) capable of supporting the opposite end portions of the first damper spring 9 to the third damper spring 13 contacted with the inner plate 15 and the outer plate 17, so that the torque transmitted from the first rotating body 3 can be transmitted to the second rotating body 7 through the first damper spring 9 to the third damper spring 13.

The first rotating body 3 may have a cross-sectional shape forming a space covering the first damper spring 9, the second damper spring 11 and the third damper spring 13 together with the second rotating body 7. A hub part coupled to the crankshaft 1 may be provided at the central portion thereof, and a circumference surface with a constant diameter at which the rotor 5 can be mounted may be formed at the outer side thereof.

Naturally, at the center of the second rotating body 7 may be formed as a spline 19, for example, into which a transmission input shaft is inserted to receive power.

For reference, at the outer side of the rotor 5 may be provided with a stator 21 disposed to form an air gap so that the motor is configured, and the stator 21 may be configured to be fixed at an engine block or a transmission housing, for example.

As described above, in the present disclosure, the structure of the motor and the damper are almost integrated, so that the lengths of the conventional motor and damper that occupy separately can be reduced, thereby contributing to reduce the entire length of a power train from an engine to a transmission and providing the damping performance required at a vehicle sufficiently while greatly improving vehicle mountability.

Although specific embodiments of the present disclosure has been described and illustrated, those skilled in the art will appreciate that various alternations and modifications are possible without departing from the technical spirit of the present disclosure as disclosed in the appended claims.

1. A damper for an engine mounted with a motor, comprising:
a first rotating body directly connected with an end portion of a crankshaft;
a rotor constituting the motor and being integrally mounted at the first rotating body;
a second rotating body installed at an inner side of the first rotating body to be rotatable relative to the first rotating body; and
a first damper spring, a second damper spring and a third damper spring installed to be elastically deformed along a circumference direction between the first rotating body and the second rotating body; and
wherein the first damper spring, the second damper spring and the third damper spring are all disposed within the length along the axial direction of the motor.

2. The damper for the engine mounted with the motor of claim 1, wherein the second damper spring is configured to be inserted into the outer side of the first damper spring.

3. The damper for the engine mounted with the motor of claim 2, wherein an inner plate configured to pressurize the end portions of the first damper spring and the second damper spring along a circumference direction, and an outer plate configured to pressurize an end portion of the third damper spring along a circumference direction, are integrally provided at the second rotating body.

4. The damper for the engine mounted with the motor of claim 3, wherein the inner plate and the outer plate include cross-sectional shapes widening relative to each other toward the outer side along the radial direction of the second rotating body.

5. The damper for the engine mounted with the motor of claim 3, wherein:
the first rotating body has a cross-sectional shape forming a space covering the first damper spring, the second damper spring and the third damper spring together with the second rotating body;
a hub part coupled to the crankshaft is provided at the central portion thereof; and
a circumference surface with a constant diameter at which the rotor can be mounted is formed at the outer side thereof.

6. The damper for the engine mounted with the motor of claim 3, wherein a spline into which a transmission input shaft is inserted is formed at the center of the second rotating body.

7. A motor for a hybrid vehicle, comprising:
the damper of claim 1; and
a stator disposed at the outer side of the rotor while forming an air gap.

8. A power train for a hybrid vehicle, comprising:
a motor including the damper of claim 1 and a stator disposed at the outer side of a rotor while forming an air gap; and
a transmission having an input shaft connected with the second rotating body.
